(19) United States
(12) Patent Application Publication
(10) Pub. No.: US 2023/0019028 A1
(43) Pub. Date: Jan. 19, 2023

(54) Multi-Purpose Receptacle Lid Securement System

(71) Applicant: Evan Tull, Coatesville, PA (US)

(72) Inventor: Evan Tull, Coatesville, PA (US)

(21) Appl. No.: 17/489,883

(22) Filed: Sep. 30, 2021

Related U.S. Application Data
(60) Provisional application No. 63/223,216, filed on Jul. 19, 2021.

(51) Int. Cl. B65F 1/16; B65D 45/16

(52) U.S. Cl. CPC B65F 1/1615; B65D 45/16

(57) ABSTRACT

The present invention relates to a multipurpose lid securement system. The securement system can be used for trash cans, ice chests, storage boxes and other types of boxes that have a lid. More specifically, the system includes a round hook-like piece on the body of the receptacle and an extendable T-shaped handle attached to the lid. The T-shaped handle can be attached to an elastic band to facilitate users pulling the handle downward toward the hook. In order to secure the lid to the top of the receptacle, the T-shaped handle is elastically secured to the underside of the hook. Securing the handle to the underside of the hook tightly secures the lid to the body of the receptacle. The lid is kept closed until the T-shaped handle is manually moved from the underside of the hook.

### CROSS-REFERENCE TO RELATED APPLICATION

The present application claims priority to, and the benefit of, U.S. Provisional Application No. 63/223,216, which was filed on Jul. 19, 2021, and is incorporated herein by reference in its entirety.

### FIELD OF THE INVENTION

The present invention relates generally to the field of trash cans and containers. More specifically, the present invention relates to a lid securement system for tightly securing the lid of a receptacle (i.e. trash can or container) thereby allowing receptacles to be stored outdoors without worry of animals or inclement weather removing or blowing debris from the trash bags. The securement system can be used with other types of storage boxes that are covered by a lid, such as ice chests, storage boxes and more. The securement system includes an arcuate hook-like piece on the body of the trash can and an expandable or stretchable T-shaped portion or rubber piece attached to the lid. The rubber piece can be pulled down and secured on an underside of the hook piece, thereby allowing the lid to be secured tightly. The securement system can be integrated to the receptacle during manufacturing, or can be attached as an aftermarket product. Accordingly, the present disclosure makes specific reference thereto. Nonetheless, it is to be appreciated that aspects of the present invention are also equally applicable to other like applications, devices, and methods of manufacture.

### BACKGROUND

By way of background, trash cans, receptacles and other devices having lids or doors are used for storing items such as garbage, recyclables, dirty laundry, pet food, etc. In particular, outdoor trash cans are used for household and other types of trash and debris. Generally, the lids and doors provide the functionality of preventing the escape of the contents from the receptacle; and to a limited degree, ingress from insects, pests and nuisance animals. However, these lids and doors are loose without an easy fastening or locking mechanism. This causes great difficulty in keeping these lids closed in inclement weather. Lids can be easily blown open by strong winds, thereby allowing escape of trash and debris from the receptacle, and creating litter within the environment.

Further, animals both domesticated and wild can easily remove or open the lids of such receptacles, work their way into the receptacles and tear through the trash bags and other debris stored therein. This leads to an unsanitary hazard for the animals and also leads to a mess, requiring clean-up.

The leakage and escape of the trash and debris, due to loose or removed lids, does not only cause unsanitary hazards but also causes problems for the garbage and recycling industry. Personnel may end up spending more time in collecting and gathering the trash, recyclables and non-recyclable contents that may have been disturbed by pests or wind due to the inadequate securement of lids to the base of the receptacle.

Although conventional locking mechanisms for such trash cans are functionally useful, they are not secure and effective. Further, heretofore known locking mechanisms are hard to use and are cost-prohibitive. A single locking mechanism may not be applicable to all types of trash cans and other similar receptacles.

Therefore, there exists a long felt need in the art for an improved locking system that can be used with any type of trash receptacle. There is also a long felt need in the art for an improved locking system that eliminates the blowing open of receptacle lids due to inclement weather. Additionally, there is a long felt need in the art for an improved locking system that prevents removal of the lids of trash receptacles by animals and pests. Moreover, there is a long felt need in the art for an improved locking system that can be used for other types of receptacles and not only for trash receptacles. Further, there is a long felt need in the art for an improved locking system that can be readily used by the garbage and recycling industry for outdoor trash receptacles. Furthermore, there is a long felt need in the art for an improved locking system that maintains a secure and hygienic environment. Finally, there is a long felt need in the art for an improved locking system that requires the manual interaction of a user to open a lid of a receptacle and thus prohibits removal or opening of the lid due to animals, pests or inclement weather.

The subject matter disclosed and claimed herein, in one embodiment thereof, comprises a trash can lid securement system that is designed to secure the lid of a trash can or container. More specifically, the trash can lid securement system comprises a hook-like piece designed to be attached on the body or base of the trash can or receptacle, and a T-shaped rubber or elastic piece attached to the lid via an extendable band. The hook-like piece can be permanently or detachably-attached to the trash receptacle base, and the T-shaped rubber piece can be secured to the underside of the hook-like piece for tightly securing the lid on top of or over the receptacle.

In this manner, the multipurpose lid securement system of the present invention accomplishes all of the forgoing objectives, and provides users with a securement system for trash receptacle lids, and other types of storage container lids, capable of preventing overflow and contents stored therein from blowing away and from pest ingress. In particular, the system allows trash receptacles to be stored outdoors without worry of animals or inclement weather from opening the container lid and tossing debris from the trash bags. The present invention enables the lid to remain closed and requires manual release of the T-shaped rubber piece to release the lid for accessing the contents stored in the receptacle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash can lid securement system. The trash can lid securement system is designed to secure the lid of the trash can receptacle. More specifically, the trash can lid securement system comprises a hook-like piece designed to be attached on the body or base of the trash can or receptacle and a T-shaped rubber piece attached to the lid via an extendable band. The hook-like piece can be permanently or detachably-attached to the trash receptacle and the T-shaped rubber piece can be secured to the underside of the hook-like piece for tightly securing the lid on the top of the receptacle.

In yet another embodiment, the T-shaped rubber piece and the extendable band are molded as a single unit, and a portion of the band can be attached to an inner surface of the lid prohibiting the lid from being removed/displaced until the T-shaped rubber piece is released from the underside of the hook-like piece.

In yet another embodiment, the T-shaped rubber piece can be pulled and extended to a position below the hook-like piece and secured with the T-shaped rubber piece on the underside of the hook-like piece.

In yet another embodiment of the present invention, a securement system for a lid of a receptacle is disclosed. The system includes an arcuate hook-like piece, designed to be attached on the body of the receptacle and a T-shaped rubber piece attached to the lid of the receptacle via an extendable band. The extendable band can be attached to the lid and the T-shaped rubber piece can be secured on the underside of the hook that locks the lid into a secured position on the top of the receptacle, and prevents the lid from being removed until the T-shaped rubber piece is manually released from underside of the hook.

In yet another embodiment of the present invention, a trash can with an integrated pull-based lid securement system is disclosed. The trash can includes: a trash receptacle having a cavity to store trash and debris therein; a lid designed to be positioned on top of the receptacle which can be removed to access the cavity and stored trash and debris therein; a small hook attached to the receptacle wherein the hook can be of an arcuate shape; a T-shaped piece or portion attached to an extendable band wherein the band is attached to the lid; and the T-shaped piece or portion can be designed to secure on the underside of the hook, thereby enabling the lid to secure tightly on the top of the receptacle to eliminate overflow and keep all trash contained inside the receptacle. The T-shaped piece or portion can be manually released from the underside of the hook, which enables the lid to be opened from the top of the receptacle.

In yet another embodiment of the present invention, a method for securing the lid tightly on the top of a receptacle is described. The method includes the steps of placing the lid on the top of the receptacle, pulling the T-shaped piece down and securing it on an underside of the hook, wherein the hook is positioned on the receptacle, and when the T-shaped piece or portion is secured on the underside of the hook, the lid is secured tightly as the T-shaped piece stretches the extendable band whose portion is fastened to the lid. For releasing the lid, the T-shaped piece is released from the underside of the hook by pulling the T-shaped piece downward and outward to release and disengage from the hook.

In yet another embodiment of the present invention, the securement system for trash receptacle lids prevents overflow and trash from blowing away, and allows trash receptacles to be stored outdoors without worry of animals or inclement weather opening the receptacle lid, whereby the lid is kept closed until manual interaction for releasing the band from the hook is actuated by a user.

In yet another embodiment, the securement system can be used for any type of receptacle that includes a lid wherein the lid needs to be secured tightly to protect the contents stored therein. Further, the securement system can come in different sizes and configurations to attach to various types of receptacles and can be integrated or attached as per the desires of the users.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose lid securement system of the present invention in accordance with the disclosed architecture;

FIG. 2 illustrates a perspective view of one potential embodiment of a trash can with the integrated multipurpose lid securement system of the present invention in accordance with the disclosed architecture;

FIG. 3 illustrates a perspective view of another embodiment of a T-shaped rubber piece having a hole for receiving an extendable band to secure to the lid in accordance with the disclosed architecture;

FIG. 4 illustrates a perspective view showing how the T-shaped rubber piece is pulled downward and outward from the arcuate hook device to release the lid in accordance with the disclosed architecture;

FIG. 5 illustrates a perspective view showing how the T-shaped rubber piece is used for securing to the arcuate hook device to lock the lid of a receptacle in accordance with the disclosed architecture;

FIG. 6 illustrates a perspective view of an ice chest with an integrated multipurpose lid securement system of the present invention in accordance with the disclosed architecture; and

FIG. 7 illustrates a perspective view of a storage box with an integrated multipurpose lid securement system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved locking system that can be used with any type of trash receptacle. There is also a long felt need in the art for an improved locking system that eliminates blowing open of receptacle lids due to inclement weather. Additionally, there is a long felt need in the art for an improved locking system that prevents removal of the lids of trash receptacles by animals and pests. Moreover, there is a long felt need in the art for an improved locking system that can be used for other types of receptacles. and not only for trash receptacles. Further, there is a long felt need in the art for an improved locking system that can be readily used by the garbage and recycling industry for outdoor trash receptacles. Furthermore, there is a long felt need in the art for an improved locking system that maintains a secure and hygienic environment. Finally, there is a long felt need in the art for an improved locking system that requires manual interaction, i.e. single-handed manual interaction, of a user to open a lid of a receptacle and thus prohibits removal or opening of the lid due to animals, pests or inclement weather.

The present invention, in one exemplary embodiment, includes a novel securement system for a lid of a receptacle/trash can. The securement system includes an arcuate hook-like piece or portion designed to be attached on the body or base of the receptacle, and a T-shaped rubber piece attached to the lid of the receptacle via an extendable band. The extendable band can be attached to the lid, and the T-shaped rubber piece can be secured on the underside of the hook that locks the lid into a secured position on the top of the receptacle and prevents the lid from being removed until the T-shaped rubber piece is manually released from the underside of the hook.

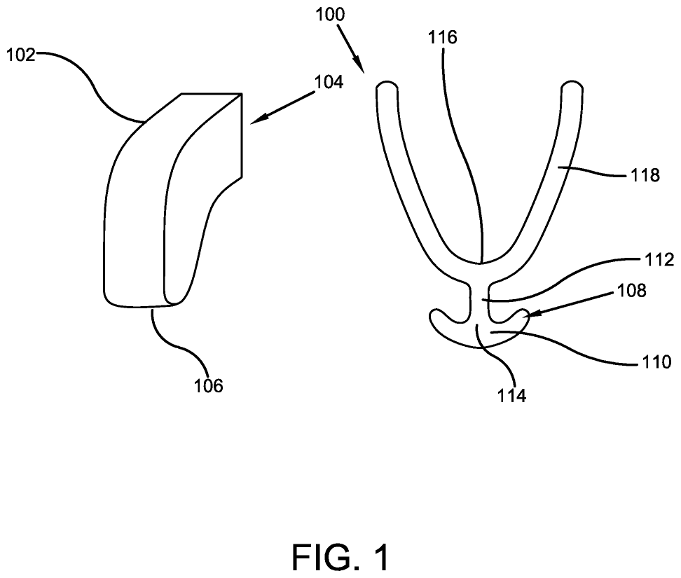

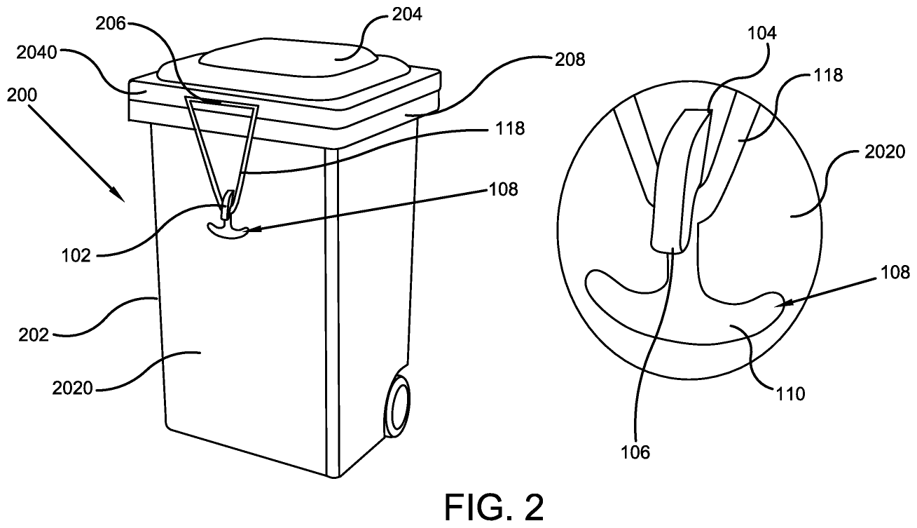

Referring initially to the drawings, FIG. 1 illustrates a perspective view of one potential embodiment of the multipurpose lid securement system of the present invention in accordance with the disclosed architecture. The multipurpose lid securement system 100 of the present invention is used for securing a lid of a trash receptable, ice cream cooler, ice box or the like, such that the lid cannot blow away in the wind or during inclement weather, and cannot be removed by an animal. More specifically, the trash can lid securement system 100 includes a round hook-like piece 102 and a T-shaped rubber piece 108 with an attached extendable band 118. The hook-like piece 102 is of an arcuate faucet or downturned shape, and includes a first or proximal end 104 that is attached to the receptable and a second or distal end 106 is the free end, such that a free space exists between the second end 106 and the receptable. The T-shaped rubber piece 108 includes a horizontal arcuate arm 110 and a vertical arm 112 extending from a middle of the horizontal arcuate arm 110. A top end 114 of the vertical arm 112 is attached to the middle of the horizontal arcuate arm 110, and a bottom end 116 of the vertical arm 112 is attached to an elastic band 118. The T-shaped rubber or elastic piece 108 is designed to be secured to the hook-like piece or portion 102 by extending the extendable band 118 and securing it under the hook-like piece 102 to lock the lid to the receptable as best illustrated in FIG. 2. During use, the hook-like piece 102 acts like a staple or anchor and the T-shaped rubber or elastic piece 108 acts like a hasp. In one potential embodiment, the T-shaped rubber piece 108 and the extendable band 118 are integrated to each other and are molded as a single flexible unit.

The hook-like piece 102 can be a material selected from heavy-duty plastics, metal and any other sturdy and durable material, and can be of any color. The T-shaped rubber piece 108 can be flexible and can be a material selected from a rubber, a silicone or a plastic. The elastic band 118 can be a material selected from a natural or synthetic rubber.

FIG. 2 illustrates a perspective view of one potential embodiment of a trash can 200 with integrated multipurpose lid securement system 100 of the present invention in accordance with the disclosed architecture. The multipurpose lid securement system 100 of the present invention is used for securing the lid 204 of the trash receptable 202, such that the lid 204 cannot blow away in wind or inclement weather, nor be removed by an animal. The arcuate hook-like piece 102 can be integrated to the front surface 2020 of the trash receptable 202. The first or proximal end 104 of the hook piece 102 can be attached to the front surface 2020. The free or distal end 106 allows the T-shaped rubber piece 108 to secure to the hook-like piece 102 by enabling a user to single-handedly pull the T-shaped rubber piece 108 under the hook-like piece 102. The extendable band 118 is integrated to the T-shaped rubber piece 108 and a portion 206 of the extendable band 118 is secured/fastened to the front surface 2040 of the lid 204 that allows the lid 204 to be pulled down when the T-shaped rubber piece 108 is pulled down by the user and the lid 204 abuts with the top 208 of the trash receptacle 202 to close the opening of the trash can 200, for preventing overflow and for preventing trash from being blown or pulled away. The receptacle lid 204 is kept closed until the T-shaped rubber piece 108 is released from under the hook-like piece 102.

The portion 206 can be secured to the front surface 2040 by permanently or detachably fastening the band 118. An adhesive can be used to secure the portion 206 to the front surface 2040 of the lid 204. Alternatively, mechanical fasteners such as screws can be used to fasten the portion 206 to the front surface 2040 of the lid 204. During use, the hook-like piece 102 acts like a staple and the T-shaped rubber piece 108 acts like a hasp.

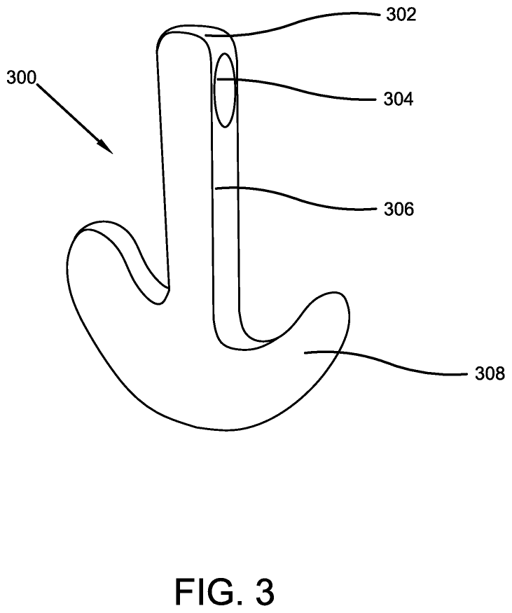

FIG. 3 illustrates a perspective view of another embodiment of T-shaped rubber piece having a hole for receiving extendable band to secure to the lid in accordance with the disclosed architecture. The T-shaped rubber piece 300 of the present embodiment works in a manner similar to the integrated T-shaped rubber piece of the other embodiments described supra and attaches to the extendable band allowing the T-shaped rubber piece 300 to be stretched down below the hook-like piece for securing to the hook-like piece or portion. In the present embodiment, the bottom end 302 of the vertical arm 306 includes a hole 304 for receiving the elastic band. This enables a user to single-handedly grip the T-shaped rubber piece 300 using the horizontal arcuate arm 308 and stretch the extendable band. The hole 304 allows the extendable band to be replaced easily in cases where the band becomes loose or loses its elasticity.

It should be noted that the securement system/trash can lid securement system 100 of the present invention can be integrated to the trash can or other container devices during manufacturing or can be detachably-attached as an aftermarket product. The arcuate hook device is positioned near the opening of the receptable so that even a small length of the extendable arm can help in keeping the lid securely closed. The extendable band can be attached to either the exterior or interior surface of the lid of the receptable, thereby allowing the T-shaped rubber piece to pull the lid by pulling the extendable band downward. When the T-shaped rubber piece is secured to the hook-like piece, the extendable band secures the lid to close and secure the opening of the receptable, and does not allow the lid to open until the T-shaped rubber piece is manually disengaged from under the hook-like piece. This prevents the wind, inclement weather, and/or animals from opening or removing the lid for tossing debris from the trash container. Further, the secured closed lid eliminates overflow and keeps all trash contained inside the receptacle.

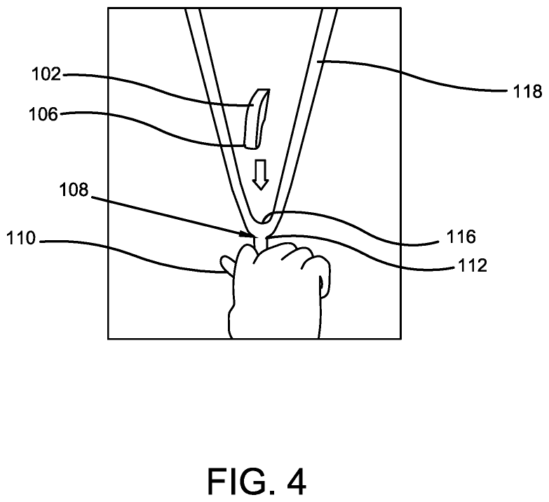

FIG. 4 illustrates a perspective view showing how the T-shaped rubber or elastic piece is pulled down from the arcuate hook device to release the lid in accordance with the disclosed architecture. For releasing the lid of a receptacle, the T-shaped rubber piece 108 is pulled downward from its retained position under the hook device 102. The T-shaped rubber piece 108 can be pulled downward by holding the horizontal arcuate arm 110 such that the bottom end 116 of the vertical arm 112 is pulled vertically below the free or distal end 106 of the hook device 102. Then, the T-shaped rubber piece 108 and the integrated band 118 is pulled away or outward from the trash receptacle 202 to a distance greater than the total length or extension of the hook device 102, so that when the T-shaped rubber piece 108 is released, it is not obstructed by the hook device 102. Thus, when the T-shaped rubber piece 108 is released, the lid of the receptacle 202 is released and can then be opened/removed for extracting or dumping the trash bags and other bags stored in the trash can.

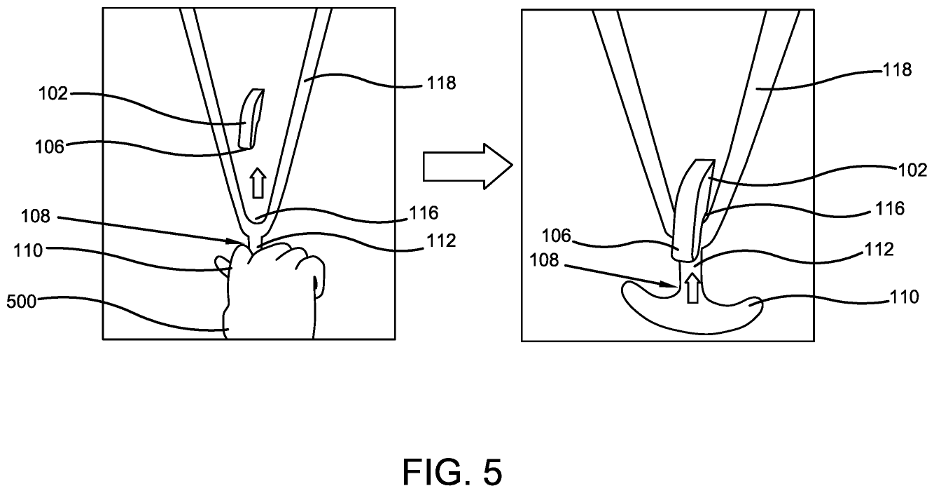

FIG. 5 illustrates a perspective view showing how the T-shaped rubber piece is used for securing to the arcuate hook device to lock the lid of a receptacle in accordance with the disclosed architecture. For locking the lid of a receptacle, initially, the T-shaped rubber piece 108 is pulled down to a position under the hook device 102. As shown, the T-shaped rubber piece 108 is pulled down single-handedly by a user by holding the horizontal arcuate arm 110 using hand 500 such that the bottom end 116 of the vertical arm 112 is pulled vertically below the free end 106 of the hook device 102. The pulling action causes the lid attached to the extendable arm to reach the top of the receptacle to which the hook device 102 is attached. Then, the T-shaped rubber piece 108 can be released to retract and secure under the hook device 102, thereby preventing any movement of the lid due to inclement weather or by any animal when the T-shaped rubber piece 108 is positioned under the hook device 102. The hook device 102 acts as a barrier for prohibiting the upward movement of the T-shaped rubber piece 108 and thus necessitates manual interaction with the band 118 and hook 102 to unlatch and open the lid.

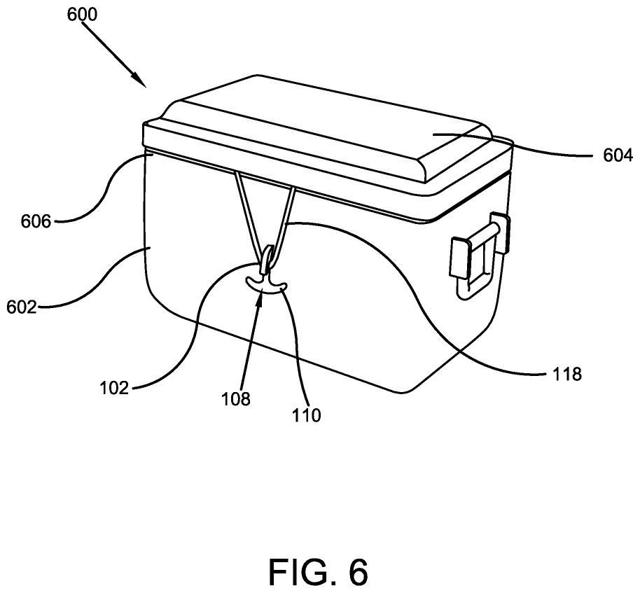

FIG. 6 illustrates a perspective view of an ice chest 600 with the integrated multipurpose lid securement system 100 of the present invention in accordance with the disclosed architecture. As shown, the hook 102 is positioned on the ice chest receptacle 602 and the T-shaped piece or portion 108 attached to the band 118 is secured to the underside of the hook 102 to tightly secure the lid 604 on top 606 of the chest receptacle 602. For removing or opening the lid 604, the T-shaped piece 108 is released from the locked position of being on the underside of the hook 102.

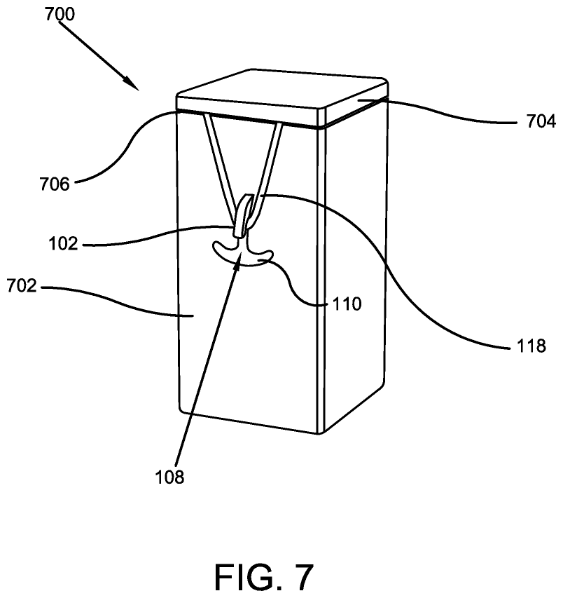

FIG. 7 illustrates a perspective view of a storage box 700 with the integrated multipurpose lid securement system 100 of the present invention in accordance with the disclosed architecture. As shown, the hook 102 is positioned on the storage box receptacle 702 and the T-shaped piece or portion 108 attached to the band 118 is secured to the underside of the hook 102 to tightly secure the box lid 704 on top 706 of the storage box receptacle 702. For removing the lid 704, the T-shaped piece 108 is released from the locked position on the underside of the hook 102.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose lid securement system”, “securement system”, “pull-based lid securement system”, “trash can lid securement system”, and “system”, are interchangeable and refer to the multipurpose lid securement system 100 of the present invention.

Notwithstanding the forgoing, the multipurpose lid securement system 100 of the present invention can be of any suitable size and configuration as is known in the art without affecting the overall concept of the invention, provided that it accomplishes the above-stated objectives. One of ordinary skill in the art will appreciate that the size, configuration, and material of the multipurpose lid securement system 100 as shown in the FIGS. are for illustrative purposes only, and that many other sizes and shapes of the multipurpose lid securement system 100 are well within the scope of the present disclosure. Although the dimensions of the multipurpose lid securement system 100 are important design parameters for user convenience, the multipurpose lid securement system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A container lid securement system comprising:
a hook portion fixedly attached to a container base;
a T-shaped portion connected to an extendable band, wherein said extendable band is attached to a container lid;
said hook including a downturned distal free end and a proximal end, wherein said proximal end is connected to said container base;
said T-shaped portion including a generally horizontal arcuate arm and a vertical arm extending from a middle of said horizontal arcuate arm;
a top end of said vertical arm attached to a middle of said horizontal arcuate arm; and
a bottom end of said vertical arm attached to said extendable band, wherein said extendable band stretchable below said hook portion for securing said T-shaped portion to said hook and securing said container lid to said container base.

2. The container lid securement system of claim 1, wherein said container is a trash can.

3. The container lid securement system of claim 1, wherein said container is an ice cooler.

4. The container lid securement system of claim 2, wherein said extendable band is integrated with said T-shaped portion.

5. The container lid securement system of claim 4, wherein said T-shaped portion is comprised of a rubber.

6. The container lid securement system of claim 5, wherein said proximal end connected to a front surface of said container base.

7. The container lid securement system of claim 6, wherein said extendable band is attached to a front surface of said container lid.

8. The container lid securement system of claim 7, wherein said T-shaped portion comprises a flexible material selected from a group consisting of a rubber, a silicone, and a plastic.

9. The container lid securement system of claim 8, wherein said hook comprises a material selected from a group consisting of a heavy-duty plastic and a metal.

10. A container lid securement system comprising:
a hook portion fixedly attached to a container base;
a single-handed T-shaped portion connected to an extendable band, wherein said extendable band is attached to a container lid;
said hook including a downturned distal free end and a proximal end, wherein said proximal end is connected to said container base;
said single-handed T-shaped portion including a generally horizontal arcuate arm and a vertical arm extending from a middle of said horizontal arcuate arm;
a top end of said vertical arm attached to a middle of said horizontal arcuate arm;
a bottom end of said vertical arm attached to said extendable band;
said proximal end connected to a front surface of said container base; and
said extendable band is attached to a front surface of said container lid, wherein said extendable band stretchable below said hook portion for securing said single-handed T-shaped portion to said hook and securing said container lid to said container base.

11. The container lid securement system of claim 10, wherein said container is a trash can.

12. The container lid securement system of claim 10, wherein said container is an ice cooler.

13. The container lid securement system of claim 11, wherein said extendable band is integrated with said single-handed T-shaped portion.

14. The container lid securement system of claim 13, wherein said single-handed T-shaped portion is comprised of a rubber.

15. The container lid securement system of claim 14, wherein said single-handed T-shaped portion is comprised of a flexible material selected from a group consisting of a rubber, a silicone and a plastic.

16. The container lid securement system of claim 15, wherein said hook is comprised of a material selected from a group consisting of a heavy-duty plastic and a metal.

17. A method for securing a container lid to a container base, the method comprising the steps of:
attaching a hook portion to a container base;
connecting a single-handed T-shaped portion to an extendable band;
attaching said extendable band to a container lid, wherein said hook comprises a downturned distal free end and a proximal end, wherein said proximal end connected to said container base, and further wherein said single-handed T-shaped portion comprises a generally horizontal arcuate arm and a vertical arm extending from a middle of said horizontal arcuate arm;
attaching a top end of said vertical arm to a middle of said horizontal arcuate arm;
attaching a bottom end of said vertical arm to said extendable band;
connecting said proximal end to a front surface of said container base;
attaching said extendable band to a front surface of said container lid;
grasping said single-handed T-shaped portion;
pulling said single-handed T-shaped portion below said hook portion; and
releasing said single-handed T-shaped portion for securing said single-handed T-shaped portion to said hook and securing said container lid to said container base.

18. The method of claim 17, wherein said container is a trash can.

19. The method of claim 18, wherein said extendable band is integrated with said single-handed T-shaped portion.

20. The method of claim 19, wherein said single-handed T-shaped portion comprises a flexible material selected from a group consisting of a rubber, a silicone, and a plastic.
